(19) United States
(12) Patent Application Publication
(10) Pub. No.: US 2013/0145679 A1
(43) Pub. Date: Jun. 13, 2013

(54) Pheromone Glue Beetle Trap

(71) Applicant: John Henry Nenninger, Festus, MO (US)

(72) Inventor: John Henry Nenninger, Festus, MO (US)

(21) Appl. No.: 13/316,822

(22) Filed: Dec. 12, 2011

(51) Int. Cl. A01M 1/14

(52) U.S. Cl. 43/114

(57) ABSTRACT

This small hive beetle trap is constructed using common corrugated cardboard method using natural pheromones and a glue substance that's environmentally safe to the applicator, honeybees and natural pollinators. There are no chemical residues transferred to the honey or beeswax. This small hive beetle trap does not add any extraneous construction to the standard beehive. The trap is placed inside the hive around the perimeter of the foundations. Traps can be used all year long.

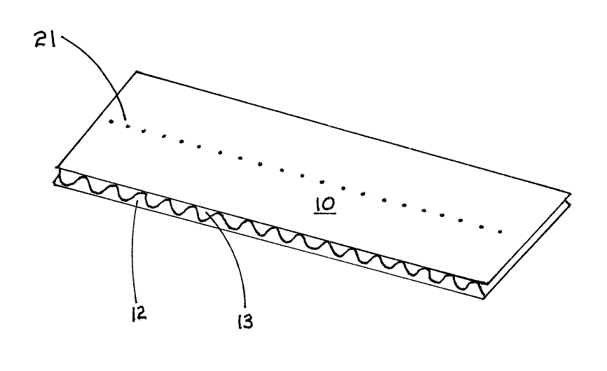

### CROSS-REFERENCE TO RELATED APPLICATIONS

### US Patent Documents

U.S. Pat. No. 8,066,988 Nov. 29, 2011 Teal; Peter E. A, Torto; Baldwyn, Tumlinson; James H, Boucias; Drion G

U.S. Pat. No. 7,879,348 Feb. 1, 2011 Volby; Stuart Allen

U.S. Pat. No. 7,757,433 Jul. 20, 2010 Levot; Garry (Orange, AU)

U.S. Pat. No. 7,632,167 Dec. 15, 2009 Miller; David

### PUBLICATION NUMBER(S)

“Not Applicable”

### STATEMENT REGARDING FEDERALLY SPONSORED

“Not Applicable”

### BACKGROUND OF THE INVENTION

U.S. Pat. No. 8,066,988 section titled “BACKGROUND OF THE INVENTION”, label number 2 “Description of the Related Art” is a comprehensive explanation of the small hive beetle's economic impact, historical information and its relationship to other pests and the honeybee.

U.S. Pat. No. 8,066,988, identified as, “In-hive trap and lure for control of the small hive beetle, Aethina tumida,” replaces an existing proven method used in conjunction with existing integrated pest management systems that helps control other pests including small hive beetles. U.S. Pat. No. 8,066,988 adds complex and additional weight to the standard honey bee hive configuration. The standard configuration of the honey bee hive consists of two hive body boxes and two honey super boxes. U.S. Pat. No. 8,066,988 cannot be used externally of the honey bee hive. This device does not prevent the adult small hive beetle from laying eggs that can result in adult small hive beetles. The addition of yeast, which is a living organism, into a honey bee hive is yet to be proven non-harmful. Yeast is a bacterium that can mutate resulting in a different strain that can be harmful in the honey bee hive ecological system.

U.S. Pat. No. 7,879,348, identified as, “Pesticide strips for control of mites in honeybees,” is a chemically treated device intended to address only the control not the elimination of Varroa mite parasites. The intent of U.S. Pat. No. 7,879,348 does not address the control or elimination of the small hive beetle. The off label use of this device to control small hive beetles has been published stating that by stapling the device to the bottom of a piece of corrugated cardboard sheet, this method intends that the small hive beetle goes into the corrugated cardboard sheet making physical contact with the chemical. The small hive beetle then exits the corrugated cardboard sheet resulting in the chemical being dispersed throughout the honeybee hive. U.S. Pat. No. 7,879,348 is simple to use and does not add complexity to the construction of a standard honey bee hive. However, the application requires the applicator to wear appropriate protective gear to avoid contact with the chemical composition. The predecessors of U.S. Pat. No. 7,879,348 have proven that the use of chemicals have developed chemically resistant pests (Varroa mite, Tracheal mite) and contribute to the decline of Native American pollinators.

U.S. Pat. No. 7,757,433, identified as, “Small hive beetle control Harbourage,” is a device primarily designed to be used with chemicals. Chemical use has been proven to be detrimental to the existence of the honeybee and natural pollinators. Chemical use has been shown to develop chemical resistant pests in the agricultural environment. This device requires assembly and disassembly of the chemically soaked corrugated cardboard. If a beekeeper uses this device he must assemble and disassemble a minimum of one for each beehive in the bee yard. These chemicals require special handling using rubber gloves and respirators. U.S. Pat. No. 7,757,433 requires the chemically soaked corrugated cardboard to be enclosed. This does not prevent the contamination of the honey and bee wax. There are no natural attractors used to entice the small hive beetle to enter into this enclosure that contains the chemical soaked corrugated cardboard. The small hive beetle naturally seeks out crevices around the perimeter of the honey bee hive foundations. If the small hive beetle enters this device it is probably due to the honeybee chasing the small hive beetle. The chemicals can be spread by the small hive beetle entering and exiting this device resulting in contamination to honey and beeswax. This device does not prevent the small hive beetle from naturally laying eggs around the perimeter of the honey bee hive. U.S. Pat. No. 7,757,433 method does not prevent the larvae from developing into adult small hive beetles.

U.S. Pat. No. 7,632,167 identified as, “Selective insect trapping system,” is a device that adds complexity to the standard honey bee hive. This device has not been and will not be accepted by industrial beekeepers or hobbyists beekeepers. This device adds weight and bulkiness to transporting of the standard honey bee hive. It does not prevent the small hive beetle using other natural methods to enter the beehive. Small hive beetles enter the beehives in early-morning or late-night. This is a characteristic trait of the small hive beetle that enters the beehive when the bees are less prone to guard their entrance. Small hive beetles that might enter this trap probably have already laid eggs in cracks and crevices within the honeybee hive. There are no pheromones used to attract small hive beetles to the opening of this device. The natural characteristics of the small hive beetle will not be drawn to a device that is external to the beehive. The adult small hive beetle will not naturally leave the beehive ecological system that the small hive beetle has genetically developed within.

U.S. Pat. Nos. 7,423,068 and 7,410,406 mentioned small hive beetles, however are not directly involved in the control or elimination of the small hive beetle. U.S. Pat. No. 7,309,274 deals with controlling small hive beetle are embedded within U.S. Pat. No. 8,066,908. U.S. Pat. No. 6,843,985 deals primarily with Varroa mites and is embedded within the U.S. Pat. No. 7,423,068.

### BRIEF SUMMARY OF THE INVENTION

This invention uses standard corrugated cardboard construction injection with natural pheromones that will attract the small hive beetle. The small hive beetle becomes trapped by glue that is applied during the manufacturing of the corrugated cardboard. The traps are placed around the perimeter of the honey bee hive frames where the small hive beetle is naturally attracted. Because the trap is non-chemical, no special equipment is required by the applicator and will not be harmful to the environment. Because this trap is placed within the beehive it will use the natural behavior of the small hive beetle. This trapping method can also be used externally to the beehive. By incorporating the pheromone and trapping agent inside existing integrated pest management devices this method could eliminate the small hive beetle from North America. This method of using corrugated cardboard and the simplicity of external constructed traps, third world countries can also employ this method to eliminate small hive beetles worldwide. There is no need to build components to be placed on the bottom, top or extend from the sides of the standard beehive.

### BRIEF DESCRIPTION OF THE DRAWING

The drawing is a pictorial view showing the corrugated cardboard construction with perforations centrally located running left to right in the corrugated strip.

### DETAILED DESCRIPTION OF THE INVENTION

The drawing shows a typical corrugated cardboard construction label 10. The corrugated areas representing by the labels 12 and 13 are sprayed with the glue substance during the construction of the corrugated cardboard. All the surfaces within the corrugated cardboard are sprayed with the glue during the construction of the corrugated cardboard. The glue will also ensure that the corrugated cardboard retains its structural integrity. Label 21, the perforated holes are made during the injection of the natural pheromones into the corrugated areas representing by the labels 12 and 13. The corrugated cardboard shall be constructed such that it can be cut into suggested strips 2 inches to 3 inches wide by 6 inches to 8 inches long. Each strip variation has the pheromone injected centrally located in the strip.

1. This invention is chemical free and can be used all year around within the beehive resulting in zero contamination of honey and beeswax.

2. This invention eliminates the possibility of genetic mutations that can result in chemical resistant honey bee pests or mites.

3. This invention uses pheromones that attract small hive beetles and a glue trapping agent to contain the adult small hive beetles.

4. This invention eliminates the need to construct additional beehive components that result in additional weight and complexity to the standard beehive components.
